(19) United States
(12) Patent Application Publication
(10) Pub. No.: US 2006/0285718 A1
(43) Pub. Date: Dec. 21, 2006

(54) Speaker

(76) Inventor: Osamu Funahashi, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/568,278

(22) PCT Filed: Aug. 2, 2005
(86) PCT No.: PCT/JP05/14069

§ 371 Date: Feb. 15, 2006

(30) Foreign Application Priority Data
Aug. 27, 2004 (JP) 2004-248046

(51) Int. Cl. H04R 9/06

(52) U.S. Cl. 381/403

(57) ABSTRACT

A speaker includes a frame, a diaphragm fixed through a first edge, a voice coil, a magnetic circuit and a suspension holder fixed through a second edge. The first and the second edges are substantially symmetrical in shape with respect to the space between them and the inner periphery of the suspension holder and the inner periphery of the diaphragm are fixed to a part outside of the magnetic gap of the voice coil. Furthermore, the magnetic circuit has a magnet provided outside of the bottom of the frame with its outer periphery extending at least beyond the center of the second edge. The magnetic gap of the magnetic circuit is pushed into the frame past the bottom of the frame. The speaker provides lower distortion and increased audio output.

### TECHNICAL FIELD

The present invention relates to speakers for use in various acoustic systems.

### BACKGROUND ART

A description of the structure of a conventional speaker will be given referring to FIG. 5. This speaker has magnetic circuit 1, voice coil 4 at least coil section 3 of which being movably provided inside magnetic gap 2 of magnetic circuit 1, diaphragm 5 inner periphery of which being coupled to an external part of magnetic gap 2 of voice coil 4, and frame 7 to which outer periphery of diaphragm 5 is coupled through edge 6. By inputting an electric signal fed from an audio amplifier and the like to coil section 3 of voice coil 4, voice coil 4 is excited, the force of excitation is transmitted to diaphragm 5, and diaphragm 5 converts the electric signal into a sound by vibrating air. An example of a speaker having such a structure is disclosed in Japanese Patent Unexamined Publication No. H11-275690.

In the above-described conventional example, as shown in FIG. 5, inner periphery of damper 8 is fixed between coil section 3 of voice coil 4 and a section of voice coil 4 where inner periphery of diaphragm 5 is fixed, and outer periphery of damper 8 is fixed to frame 7. Damper 8 forms a suspension jointly with edge 6 and prevents voice coil 4 from rolling when in motion. Also, damper 8 is formed in the shape of two or more waveforms combined in order to minimize mechanical load to voice coil 4.

However, in association with a recent trend toward higher performance of speakers, the existence of damper 8 is causing serious problems.

That is, as there is a large degree of non-linearity of mechanical load and asymmetry between the behavior of voice coil 4 moving toward magnetic circuit 1 and the behavior of moving toward a direction opposite to magnetic circuit 1, there is a possibility of generating large harmonic distortion due to this situation and, at the same time, worsening power linearity.

FIG. 6 shows power linearity of a conventional speaker, namely, amplitude (displacement) of diaphragm 5 as a function of input power to the speaker. In the figure, sign A represents amplitude characteristic of diaphragm 5 moving toward magnetic circuit 1 while sign B represents amplitude characteristic of diaphragm 5 toward a direction opposite to magnetic circuit 1. Also, FIG. 7 shows harmonic distortion characteristic of a conventional speaker. In the figure, sign C, sign D, and sign E respectively represent frequency characteristic of the speaker, second harmonic distortion characteristic, and third harmonic distortion characteristic.

In order to solve such problems of power linearity and harmonic distortions, various studies are being made to improve non-linearity and asymmetry of damper 8. As has been described above, damper 8 is structured by combining two or more waveforms in order to minimize mechanical load. Accordingly, in so far as a suspension is to be structured by combining damper 8 and edge 6, it is difficult to reduce harmonic distortions by solving the problems of non-linearity and asymmetry, and enhancement of speaker performance is not in a satisfactory state.

Therefore, a structure is proposed in recent years in which damper 8 is removed and, instead, ring-shaped suspension holder 8 is provided underneath diaphragm 5 as shown in FIG. 8, inner periphery of suspension holder 8 is fixed to voice coil 4, and outer periphery of suspension holder 8 is fixed to frame 7 through second edge 6a. And edge 6 and second edge 6a are made substantially symmetrical with respect to a space in between. That is, when edge 6 is upwardly protruding as shown in FIG. 8, second edge 6a is made to be downwardly protruding. With this structure, load unbalance in the vertical motion of diaphragm 5 associated with the shapes of protrusion of both edges is cancelled and worsening of power linearity is suppressed. This is an effort of making the two displacements of diaphragm 5 as shown by signs A and B in FIG. 6 identical.

However, there are problems to be solved with the speaker shown in FIG. 8. That is, as second edge 6a is provided, magnetic circuit 1 has to be provided innerly of second edge 6a. As a result, especially magnet 1a of magnetic circuit 1 becomes smaller making driving force of voice coil 4 smaller and presenting possibility of smaller audio output.

### DISCLOSURE OF THE INVENTION

The present invention provides a speaker that includes a concave frame having an opening on the upper side, a diaphragm provided in the opening of the frame with its outer periphery fixed to edge portion of the opening of the frame through a first edge, a voice coil provided on the bottom surface side of the diaphragm, a magnetic circuit in which at least a part of the voice coil is movably provided in the magnetic gap, and a suspension holder the outer periphery of which is fixed to the frame through a second edge on the bottom surface of the diaphragm within the frame. The first and the second edges are made symmetrical in shape with respect to a space in between, the inner periphery of the suspension holder and the inner periphery of the diaphragm are directly or indirectly fixed to the voice coil at a part outside of the magnetic gap. The magnetic circuit has a magnet provided outside of the bottom of the frame and the outer periphery of the magnet is extending at least beyond the center of the second edge. The magnetic gap of the magnetic circuit is pushed into the frame past the bottom surface of the frame.

### BRIEF DESCRIPTION OF THE DRAWINGS

FIG. 1 is a cross-sectional view of a speaker in a preferred embodiment of the present invention.

FIG. 2 is a cross-sectional view of a speaker in another preferred embodiment of the present invention.

FIG. 3 is a graph showing power linearity of the speaker shown in FIG. 1.

FIG. 4 is a graph showing harmonic distortion characteristic of the speaker shown in FIG. 1.

FIG. 5 is a cross-sectional view of a conventional speaker.

FIG. 6 is a graph showing power linearity of the conventional speaker.

FIG. 7 is graph showing harmonic distortion of the conventional speaker.

FIG. 8 is a cross-sectional view of another conventional speaker.

### REFERENCE NUMERALS IN THE DRWINGS

9 Frame
10 Diaphragm
11 First edge
12 Voice coil
13 Coil section
14 Magnetic gap
15 Suspension holder
16 Second edge
17 Magnetic circuit
18 Magnet
19 Columnar projection
20 Yoke
21 Ring-shaped plate
22 Step section
23 Air vent
24 Dust filter
25 Top plate

### DETAILED DESCRIPTION OF THE PREFERRED EMBODIMENTS

The speaker of the present invention has the following structure. The speaker includes a concave frame having an opening on the upper side, a diaphragm provided in the opening of the frame with its outer periphery fixed to the edge of the opening of the frame through a first edge, a voice coil provided on the bottom side of the diaphragm, a magnetic circuit into a magnetic gap of which at least a part of the voice coil is movably disposed, a suspension holder the outer periphery of which being fixed to the frame through a second edge on the bottom side of the diaphragm within the frame. The first and the second edges are substantially symmetrical with respect to a space in between. The magnetic circuit has a magnet provided outside of the bottom of the frame with its outer periphery extending to at least beyond the center of the second edge. The magnetic gap of the magnetic circuit passes through the bottom of the frame and reaches inside of the frame.

In this way, as the voice coil of the speaker of this invention is supported by the diaphragm, the suspension holder, and the first and the second edges having substantially symmetrical shape with respect to a space in between, smooth vertical motion of the diaphragm is made possible and the distortion of sound reproduction can be reduced. Also, as a larger magnet can be used in the speaker of the present invention, driving force of the voice coil can be increased and the audio output can be increased.

A description of an exemplary embodiment of the preferred embodiment of the present invention will be given below referring to drawings. The present invention is not limited to this exemplary embodiment. Here, drawings are schematic and do not represent dimensionally correct positional relationships.

### EXEMPLARY EMBODIMENT

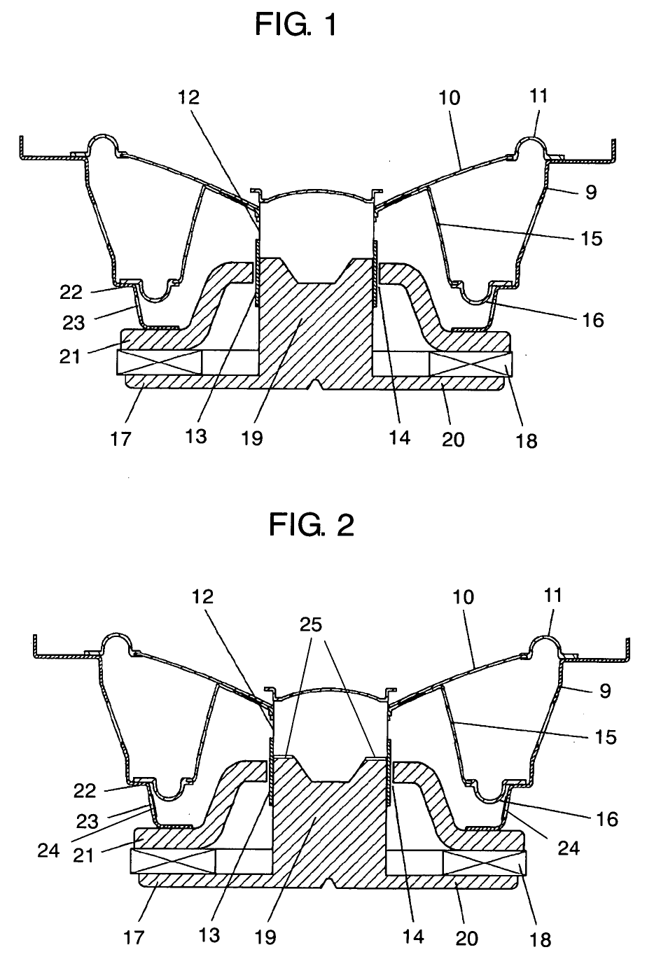

A description of this preferred embodiment will be described referring to FIG. 1 to FIG. 4. As shown in FIG. 1, concave frame 9 has an opening on the upper side and is formed by drawing a metal plate into a concave shape. Also, circular ring-shaped diaphragm 10 is provided in the upper opening of frame 9. Outer periphery of diaphragm 10 is fixed to edge section of the opening of frame 9 through ring-shaped first edge 11 made of rubber.

Cylindrical voice coil 12 is provided on the bottom side of diaphragm 10. At least lower coil section 13 of voice coil 12 is disposed in a vertically movable fashion in magnetic gap 14. Outer periphery of cylindrical trapezoidal suspension holder 15 is fixed to frame 9 through ring-shaped second edge 16 made of rubber on the bottom surface side of diaphragm 10 inside frame 9.

First edge 11 and second edge 16 are substantially symmetrical with respect to a space in between. To be more specific, first edge 11 upwardly protrudes in the form of a semicircle while second edge 16 downwardly protrudes in the form of a semicircle. Also, overlap widths of the inner periphery of suspension holder 15 and the inner periphery of diaphragm 10 are integrated with an adhesive and are further directly or indirectly fixed with an adhesive to a part outside of magnetic gap 14 of voice coil 12.

Here, a description will be given on the point of directly or indirectly fixing in the present invention. In FIG. 1, the inner periphery of suspension holder 15 and the inner periphery of diaphragm 10 are integrated and are directly fixed to the outer periphery of voice coil 12. Furthermore, the inner periphery of either, for example, diaphragm 10, may be fixed to the outer periphery of voice coil 12, and the inner periphery of suspension holder 15 may be made smaller than shown in FIG. 1 and fixed to the bottom surface of diaphragm 10 with an adhesive. Conversely, the inner periphery of suspension holder 15 may be fixed to the outer periphery of voice coil 12, and the inner periphery of diaphragm 10 may be made smaller than shown in FIG. 1 and fixed to the top surface of suspension holder 15 with an adhesive. These are the states in which either suspension holder 15 or diaphragm 10 is indirectly fixed to the outer periphery of voice coil 12.

Now, magnetic circuit 17 for forming magnetic gap 14 is provided outside of the bottom of frame 9 as shown in FIG. 1 and, at the same time, has magnet 18 outer periphery of which being extending to at least beyond the center of second edge 16. A description of further detail of magnetic circuit 17 will be given. Magnetic circuit 17 comprises yoke 20 having columnar protrusion 19 formed on the upper surface of a disc-like member, ring-shaped magnet 18 laminated on top of yoke 20, and ring-shaped plate 21 the outer periphery of which being laminated on top of magnet 18, the inner periphery of which being pushed into frame 9 together with columnar protrusion 19 of yoke 20 and forming magnetic gap 14 in the space between itself and columnar protrusion 19. Magnetic gap 14 passes through the bottom of frame 9 and reaches the central part within frame 9.

In magnetic circuit 17, disk-like yoke 20, ring-shaped magnet 18 and ring-shaped plate 21 are integrated into one piece by gluing and are secured to a part outside of the bottom surface of frame 9 with a bolt (not shown) and the like. Also, as shown in FIG. 2, magnetic gap 14 may be formed between outer periphery of top plate 25 and ring-shaped plate 21 after laminating top plate 25 on columnar protrusion 19 of yoke 20.

Also, step portion 22 is formed on a lower part on the side of frame 9 for fixing second edge 16 with an adhesive. Air vent 23 is formed on a side surface of frame 9 lower than step portion 22. Though air vent 23 is formed for ventilation, it is preferable to provide dust filter 24 as shown in FIG. 2 in order to prevent dust from entering into magnetic gap 14 through air vent 23. When doing this, dust filter 24 may be provided on the outside of frame 9 of air vent 23. Such arrangement can prevent dust filter 24 from blocking vertical motion of second edge 16.

As the size of magnet 18 of magnetic circuit 17 can be made so large that the outer periphery of magnetic 18 extends beyond second edge 16 as shown in FIG. 1, the driving force of voice coil 12 can be further increased by doing so.

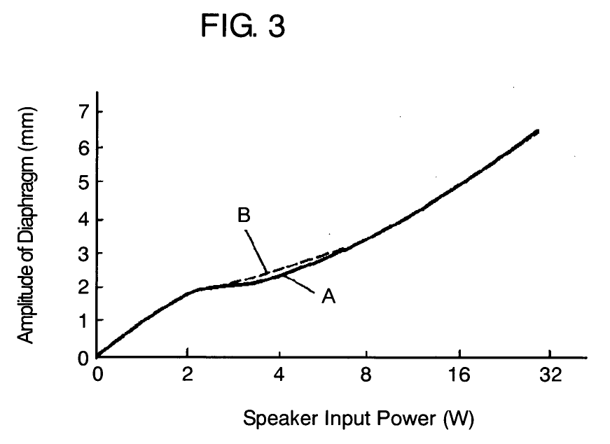

In this preferred embodiment, a suspension consisting of suspension holder 15 and second edge 16 is provided between voice coil 12 and frame 9 in place of a conventional damper. Suspension holder 15 and second edge 16 make up the suspension jointly with first edge 11 and are provided to prevent voice coil 12 from rolling when voice coil 12 is in a vertical motion. Consequently, the suspension can be structured with first edge 11 and second edge 12, and a damper which might cause non-linearity and asymmetry of a suspension can be removed. Also, first edge 11 and second edge 16 are of substantially symmetrical and analogous in shape so as to cancel intrinsic asymmetry. To put it concretely, first edge 11 and second edge 16 are oppositely disposed in order that their directions of protrusion are opposite. Owing to this, the two curves, A and B, in FIG. 3 showing power linearity are substantially identical. That is, the problems of non-linearity and asymmetry of the suspension can be basically solved in this way.

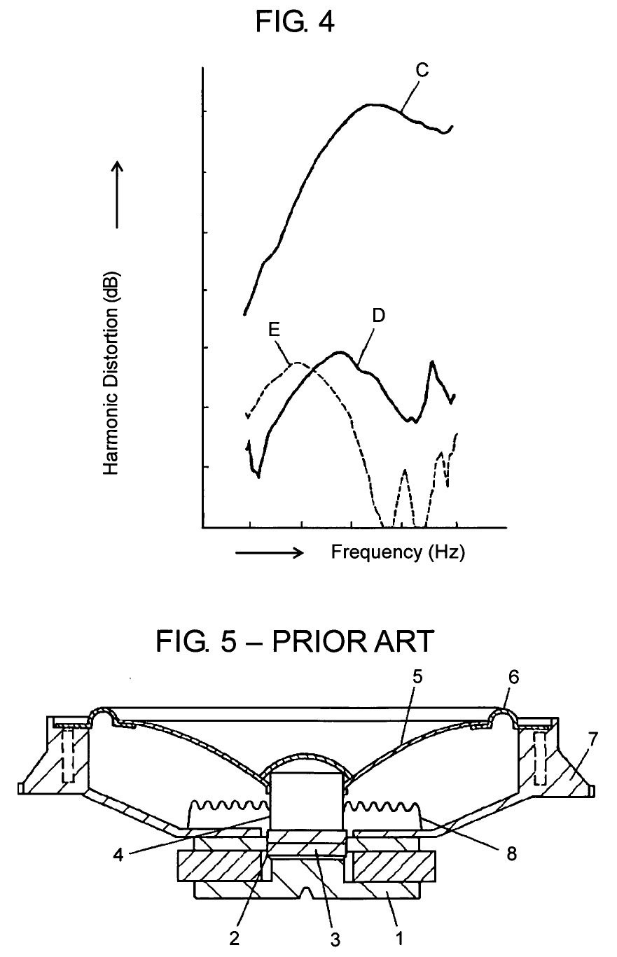

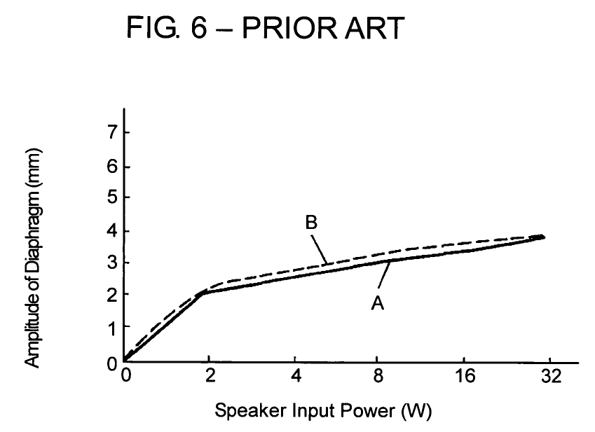

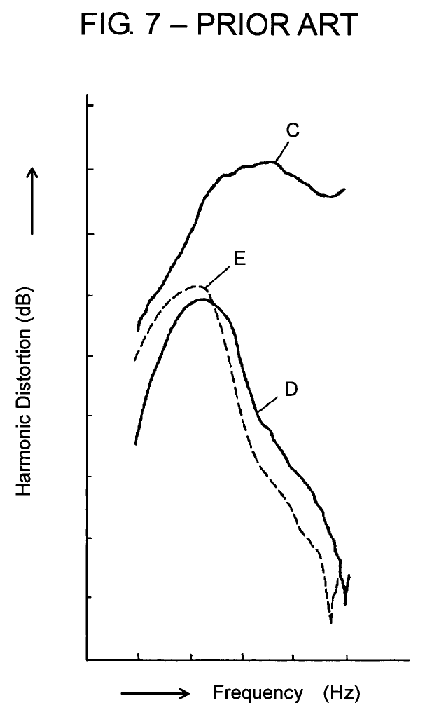

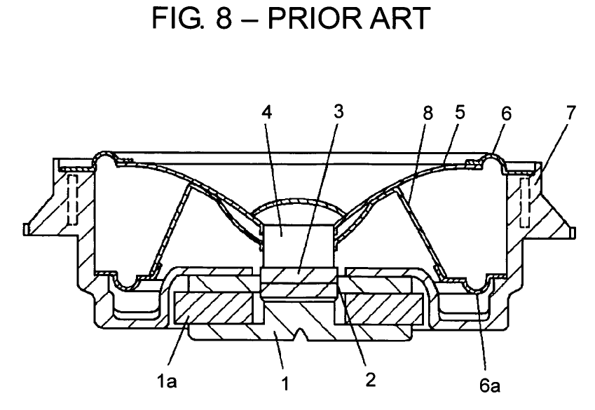

In addition, as harmonic distortions such as second and third harmonic distortion characteristics of a speaker as shown by sings D and E in FIG. 4 attributable to non-linearity and asymmetry of the suspension can be reduced, performance of the speaker can be enhanced.

In the meantime, as the magnetic material to be used in the magnetic circuit of the present invention, the materials usually used by those skilled in the art can be employed. Same thing applies to other structural materials.

### INDUSTRIAL APPLICABILITY

The present invention provides a speaker having small vibration distortion of the diaphragm yet having a large voice coil driving force. The speaker can be widely used in a variety of acoustic systems.

1. A speaker including:
a concave frame having an opening on the upper part thereof;
a diaphragm provided in the opening of the frame with outer periphery of the diaphragm being fixed to an edge of the opening of the frame through a first edge;
a voice coil provided on the bottom surface of the diaphragm;
a magnetic circuit wherein at least a part of the voice coil is movably disposed in a magnetic gap of the magnetic circuit; and
a suspension holder outer periphery thereof being fixed to the frame through a second edge on the bottom surface of the diaphragm inside the frame; wherein
the first and the second edges are substantially symmetrical with respect to a space between the first and the second edges, inner periphery of the suspension holder and inner periphery of the diaphragm are directly or indirectly fixed to the voice coil at a part outside of the magnetic gap, the magnetic circuit has a magnet provided outside of the bottom of the frame with the outer periphery of the magnet extending beyond the center of the second edge, and the magnetic gap of the magnetic circuit is pushed into the frame past bottom surface of the frame.

2. The speaker of claim 1 wherein the magnetic circuit includes:
a yoke having a columnar protrusion formed on a top surface of a plate member;
a ring-shaped magnet laminated on the yoke;
a ring-shaped plate outer periphery thereof being laminated on the magnet and inner periphery thereof being pushed into the frame together with the columnar protrusion of the yoke thereby forming a magnetic gap between the inner periphery of the ring-shaped plate and the outer periphery of the columnar protrusion.

3. The speaker of claim 1 wherein the magnetic circuit includes:
a yoke having a columnar protrusion formed on the top surface of a plate member;
a plate-shaped top plate laminated on the columnar protrusion of the yoke;
a ring-shaped magnet laminated on the yoke;
a ring-shaped plate outer periphery thereof being laminated on the magnet and inner periphery thereof being reaching inside of the frame together with the columnar protrusion of the yoke thereby forming a magnetic gap between the inner periphery of the ring-shaped plate and the outer periphery of the top plate on the columnar protrusion.

4. The speaker of claim 1 wherein a step section is formed on a lower part of a side surface of the frame for fixing the second edge and an air vent is provided on a side surface portion lower than the step section.

5. The speaker of claim 4 wherein a dust filter is provided in the air vent section.

6. The speaker of claim 5 wherein the dust filter is provided in the air vent section on an outside portion of the frame.

7. The speaker of claim 1 wherein the magnetic circuit has the magnet provided outside of the bottom of the frame and outer periphery thereof being extending at least beyond the second edge.

8. The speaker of claim 2 wherein the magnetic circuit has the magnet provided outside of the bottom of the frame and outer periphery thereof being extending at least beyond the second edge.

9. The speaker of claim 3 wherein the magnetic circuit has the magnet provided outside of the bottom of the frame and outer periphery thereof being extending at least beyond the second edge.
